(19) United States
(12) Patent Application Publication
(10) Pub. No.: US 2010/0013658 A1
(43) Pub. Date: Jan. 21, 2010

(54) Dynamic emergency escape indicator

(76) Inventor: Juei-Chao Chen, Taipei City (TW)

Correspondence Address: Juei-Chao, CHEN, P.O.BOX 46-563 Taipei, Taipei City, 10499, TW

(21) Appl. No.: 12/291,788

(22) Filed: Nov. 14, 2008

(30) Foreign Application Priority Data
Jul. 16, 2008 (TW) 097212645

(51) Int. Cl. G08B 5/00; G09F 9/33; G09F 13/00; G08B 5/36

(52) U.S. Cl. 340/815.4; 340/815.45; 340/815.53; 340/815.73

(57) ABSTRACT

A dynamic emergency escape indicator primarily comprises a base, at least one light emitting device, a panel, at least one energy storage device and one or more lighting devices. By repeatedly turning on and off the at least one light emitting device in sequence, a plurality of indicating patterns can be presented in sequence continuously, thereby delivering a dynamic indicating effect. Orientations of the lighting devices can be adjusted as needed to illuminate particular objects so as to enhance lighting and guiding effects in case of emergency.

### BACKGROUND OF THE INVENTION

1. Technical Field

The present invention relates to a dynamic emergency escape indicator, and more particularly, to an emergency escape indicator capable of providing a dynamic display effect.

2. Description of Related Art

Nowadays, buildings are constructed with an increasingly higher height. On the other hand, a fire, when breaking out, tends to spread very quickly, so people can only escape from the scene of fire in the most primitive way, i.e., walking, within the limited golden time for survival. However, as being lack of air in the initial stage when the fire breaks out, flammable materials in the building typically experience incomplete combustion and give out a massive amount of dense smoke. In this case, if people fail to flee away from the scene of fire immediately, their line of sight will most likely be blocked by the dense smoke, causing difficulty in escaping and even casualty. Therefore, in accordance with relevant statutes currently applicable, buildings must be equipped with emergency escape indicators in every emergence exit of every floor. Such emergency escape indicators, most of which are installed at entries, exits or in escape routes of all floors of public places, buildings and mansions, normally operate in a normal-on status for labeling purpose. In case a fire, earthquake, blackout or any other emergency condition takes place to cause power failure of a building, the emergency escape indicator can guide and direct fleeing people by clearly identifying the locations of emergency exits so that the fleeing people can flee away from the building. As shown in FIG. 1, a conventional emergency escape indicating light 1 for use in a building typically has a transparent indicating panel 11 disposed on a base 10. In case a fire breaks out in a higher floor of the building, a light emitting device within the base of the emergency escape indicating light 1 will illuminate the indicating panel 11 to present patterns or characters formed on the indicating panel 11, so as to guide evacuation of the fleeing people. However, the emergency escape indicators currently available present the same status no matter under normal conditions or the emergency conditions, and fail to provide the desired effect of directing and guiding people towards emergency exits and escape routes under emergency conditions. Furthermore, the fleeing people often fail to find the correct escaping direction due to inadequate light intensity or inconspicuous indication of the typical emergency escape indicating light 1 plus interference of the dense smoke at the scene of fire, thereby causing unnecessary casualties.

### BRIEF SUMMARY OF THE INVENTION

A primary objective of the present invention is to provide a dynamic emergency escape indicator, wherein the dynamic emergency escape indicator has a light emitting device disposed within a base, and an indicating panel disposed outside the base corresponding to the light emitting device. The panel is formed with a plurality of indicating patterns. The light emitting device can control a plurality of light emitting elements thereof to be turned on and off in sequence repeatedly so that the plurality of indicating patterns are presented in sequence continuously, thereby achieving a dynamic indicating and guiding effect.

A secondary objective of the present invention is to provide a dynamic emergency escape indicator, wherein the dynamic emergency escape indicator is provided with one or more lighting devices at an edge of the base, and a universal coupling is provided between the lighting devices and the base. By means of the universal coupling, the one or more lighting devices can be adjusted as desired to illuminate at different orientations or to illuminate different objects. Also, the number of the lighting devices may be increased or decreased depending on the site where the indicator is installed. The lighting devices operate in a normal-off status, and in case a fire or an emergency takes place, they will be turned on immediately to provide effective lighting and enhanced indicating, guiding as well as warning effects.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a perspective outline view of the prior art solution;

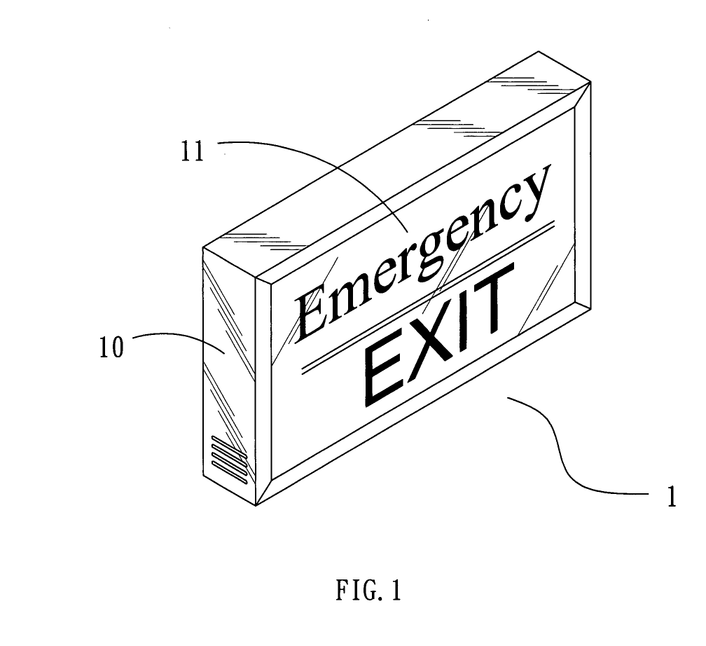

FIG. 2 is a perspective outline view of the present invention;

FIG. 3 is a perspective exploded view of the present invention;

FIG. 4 is a first applied view of a preferred embodiment of the present invention;

FIG. 5 is a second applied view of the preferred embodiment of the present invention;

FIG. 6 is a third applied view of the preferred embodiment of the present invention;

FIG. 7 is a fourth applied view of the preferred embodiment of the present invention;

FIG. 8 is a fifth applied view of the preferred embodiment of the present invention;

FIG. 9 is a sixth applied view of the preferred embodiment of the present invention;

FIG. 10 is a applied seventh view of the preferred embodiment of the present invention; and

FIG. 11 shows a further embodiment of the present invention.

### DETAILED DESCRIPTION OF THE INVENTION

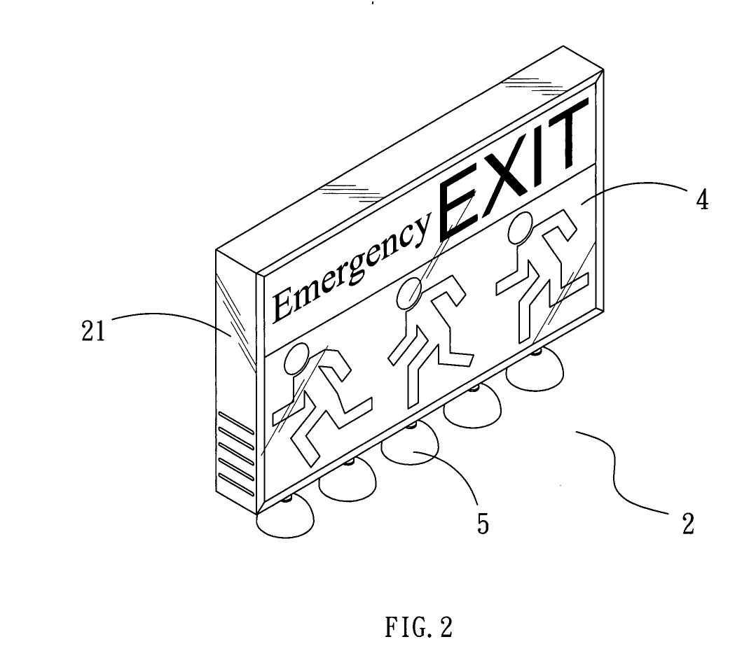

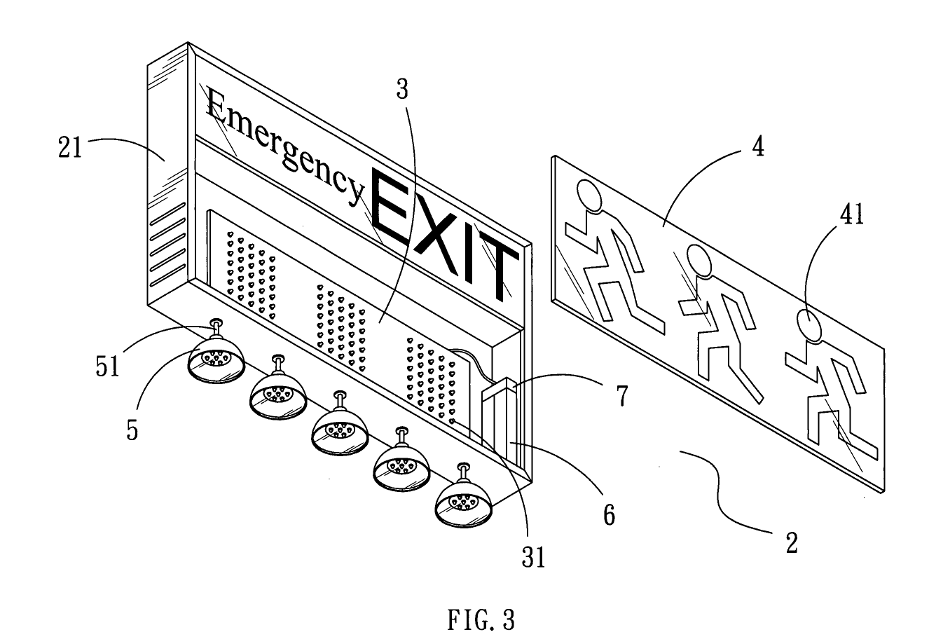

Referring to FIGS. 2 and 3, a perspective outline view and a perspective exploded view of the present invention are shown therein, respectively. As can be seen clearly from these figures, a dynamic emergency escape indicator 2 primarily comprises a base 21, at least one light emitting device 3, a panel 4, one or more lighting devices 5 and at least one power supply unit 6. The at least one light emitting device 3, which is disposed inside the base 21 along with the at least one power supply unit 6, includes a plurality of light emitting elements 31, which may be light emitting diodes (LEDs), light bulbs, halogen lamps, fluorescent lamps or any other elements that emit light. The indicating panel 4 is formed with a plurality of transparent indicating patterns 41 thereon, and is disposed on one side of the base 21 corresponding to the at least one light emitting device 3 disposed within the base 21. Additionally, each of the one or more lighting devices 5 is connected to an edge of the base 21 via a universal coupling 51. A switch device 7 (e.g., a relay) is provided in the base 21 to switch the power supply.

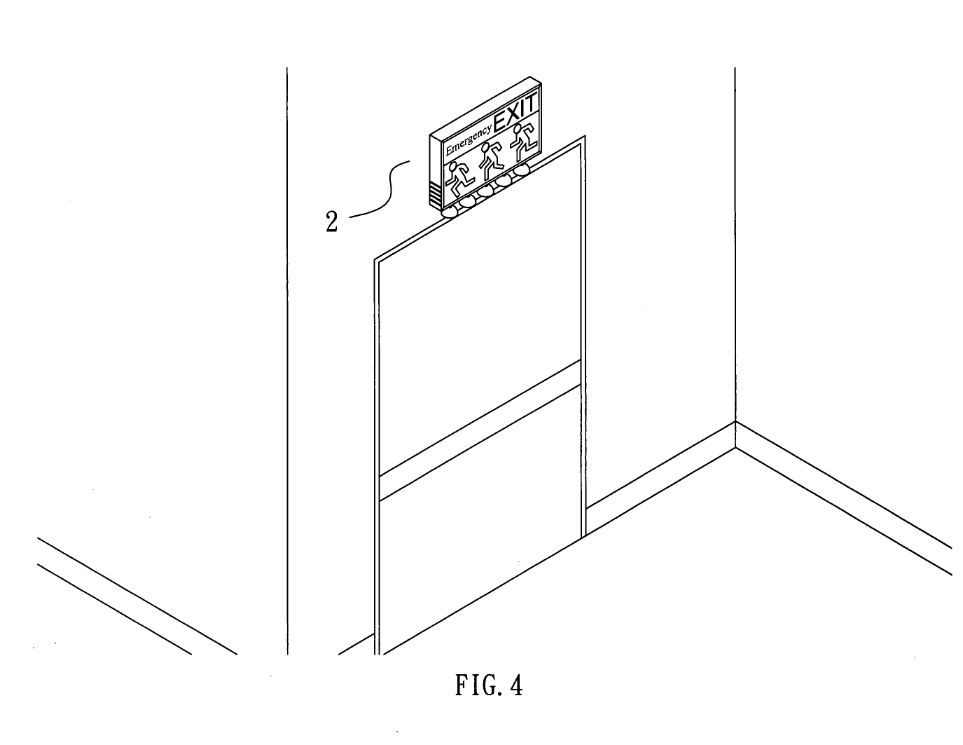

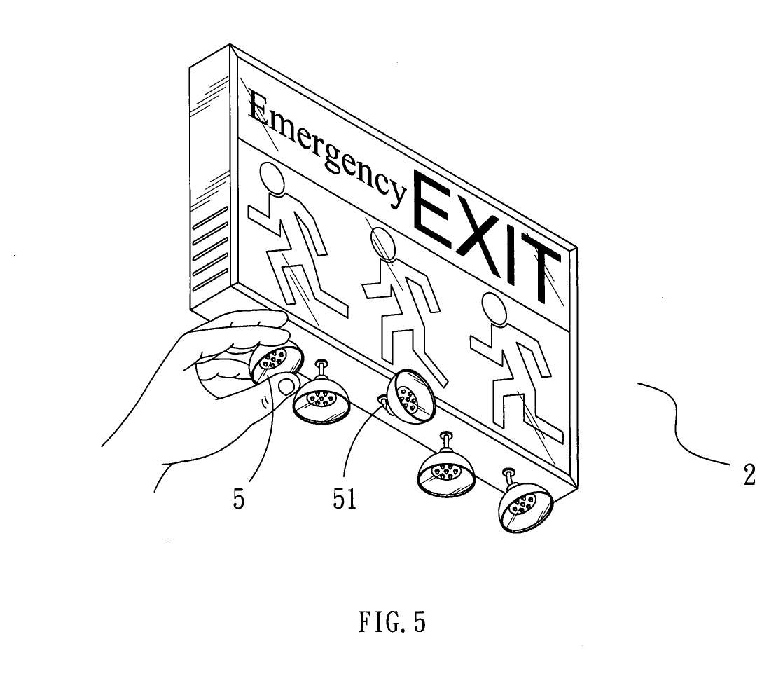

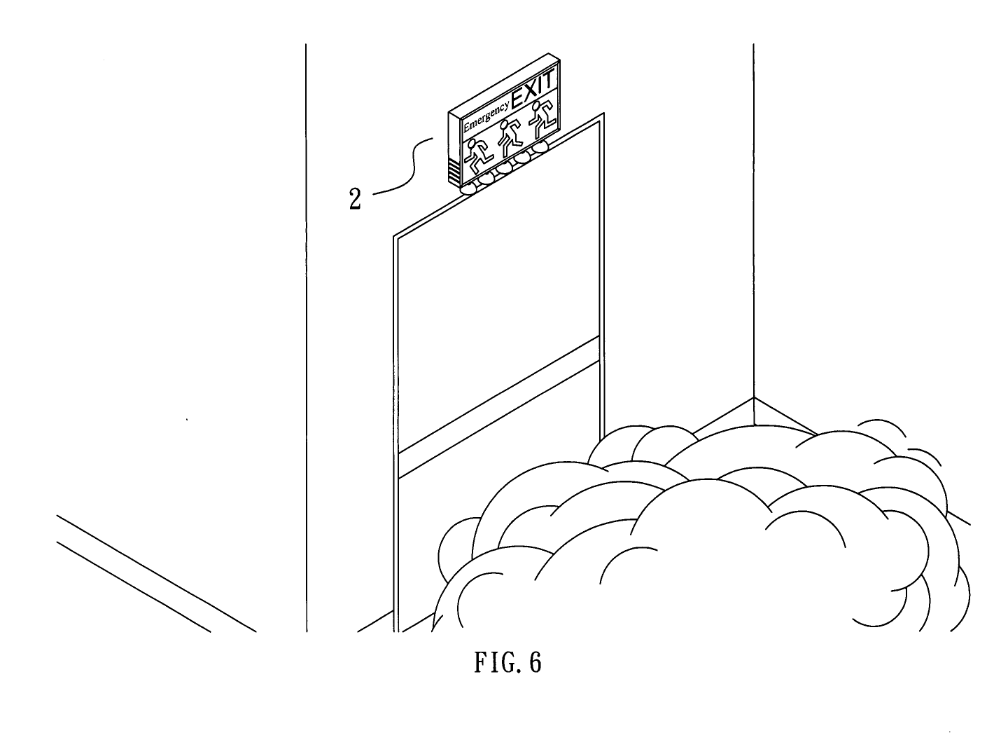

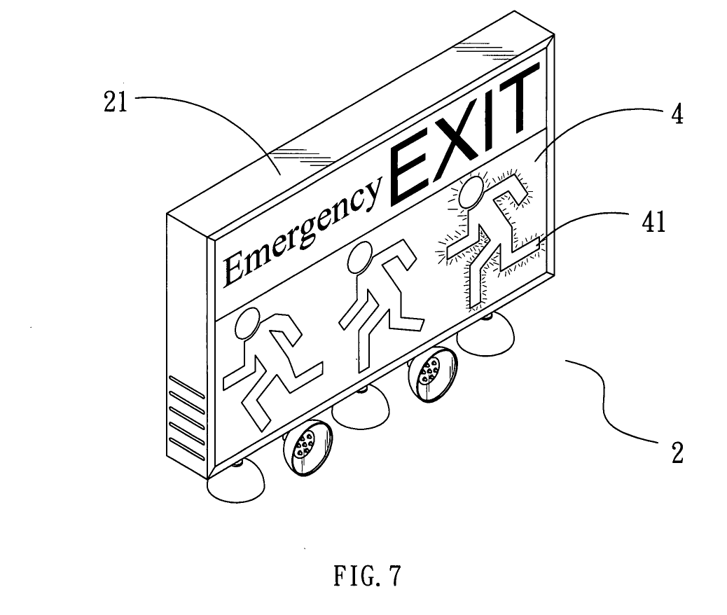

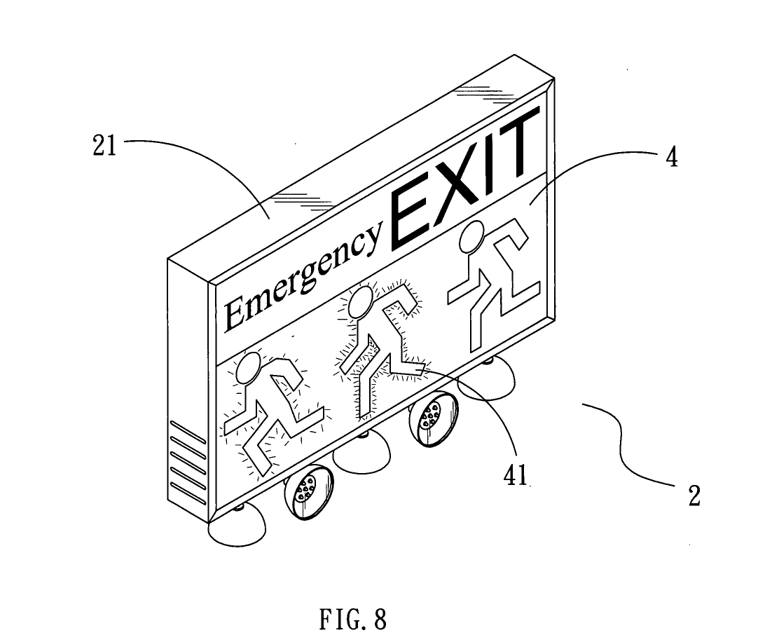

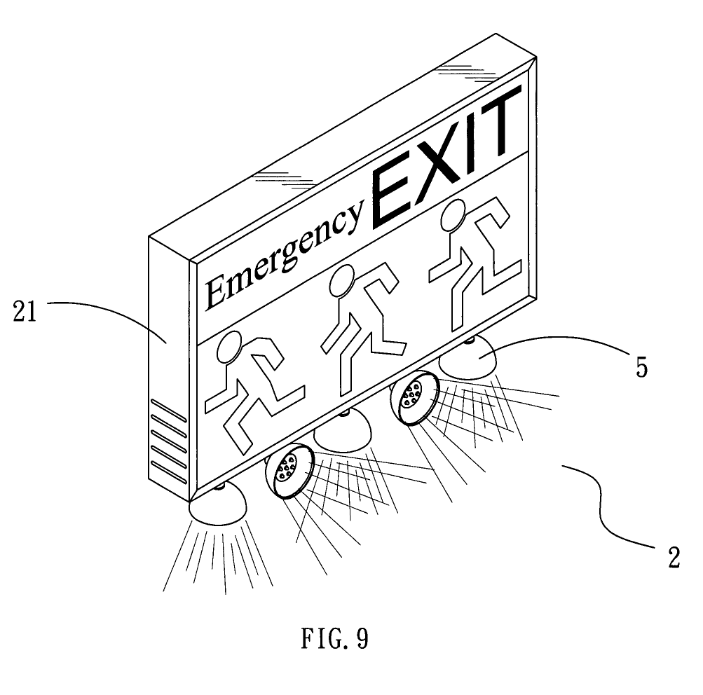

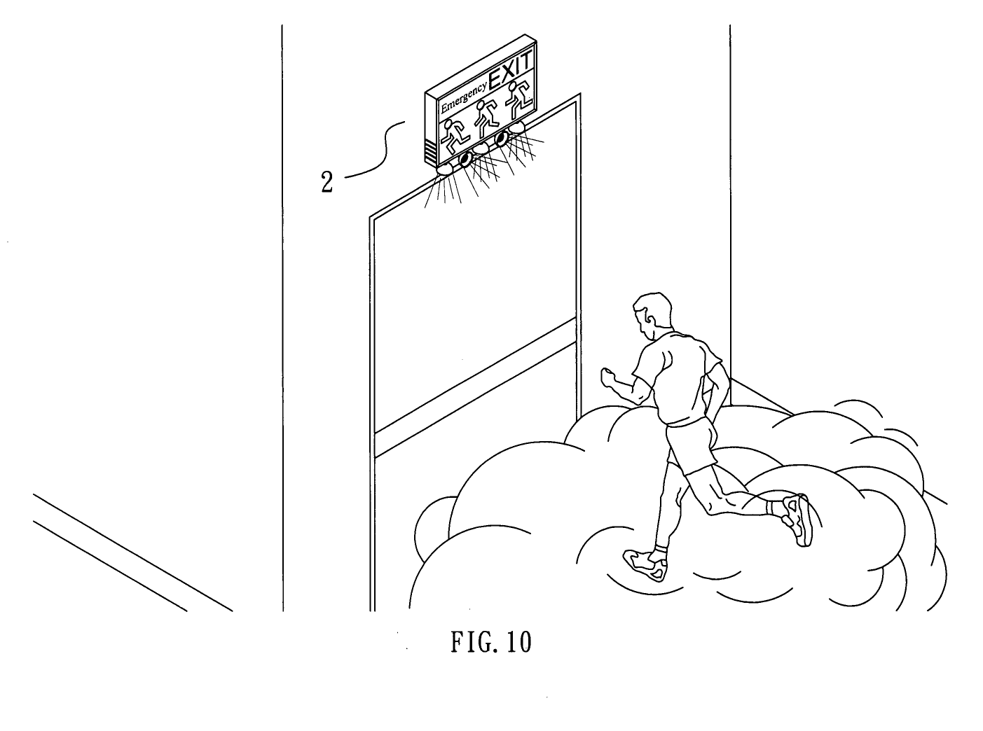

Referring to FIGS. 3, 4, 5, 6, 7, 8, 9 and 10, a preferred embodiment of the present invention is shown therein. As can be clearly seen from these figures, the dynamic emergency escape indicator 2 may be installed at an emergency exit, above an escape door or in an escape route. Orientation of the one or more lighting devices 5 disposed at the edge of the base 21 can be adjusted by respective said universal couplings 51 so as to illuminate at desired orientations or to illuminate a particular object. By adjusting the lighting devices 5 to different orientations, an enhanced lighting effect and improved warning and indicating functions can be obtained effectively in case of an emergency. Furthermore, the number of lighting lamps can be increased or decreased depending on practical needs at the site where the indicator is installed. In a standby status, the dynamic emergency escape indicator 2 is powered by the mains supply, the power supply unit 6 therein is also charged by the mains supply, and the lighting devices 5 disposed at the edge of the base 21 remain in an off status. In case of a fire, an emergency or a blackout, the switch device 7 automatically switches the dynamic emergency escape indicator 2 to be on and powered by the power supply unit 6, and the at least one light emitting device 3 disposed in the base 21 controls the light emitting elements 31 thereof to be turned on and off in sequence repeatedly, so that the plurality of indicating patterns 41 on the panel 4 can be presented in sequence continuously, thereby delivering a dynamic display effect. Meanwhile, the lighting devices 5 disposed at the edge of the base 21 are turned on to provide lighting and to illuminate a particular object (e.g., a door knob or a staircase). Thus, in case of a fire, the plurality of indicating patterns 41 on the panel 4 are presented in sequence in a dynamic and repeated manner, and the lighting devices 5 illuminate objects at different orientations. In this way, the fleeing people surrounded by the dense smoke can clearly see the dynamic emergency escape indicator 2, thereby accomplishing effective guiding and indicating functions.

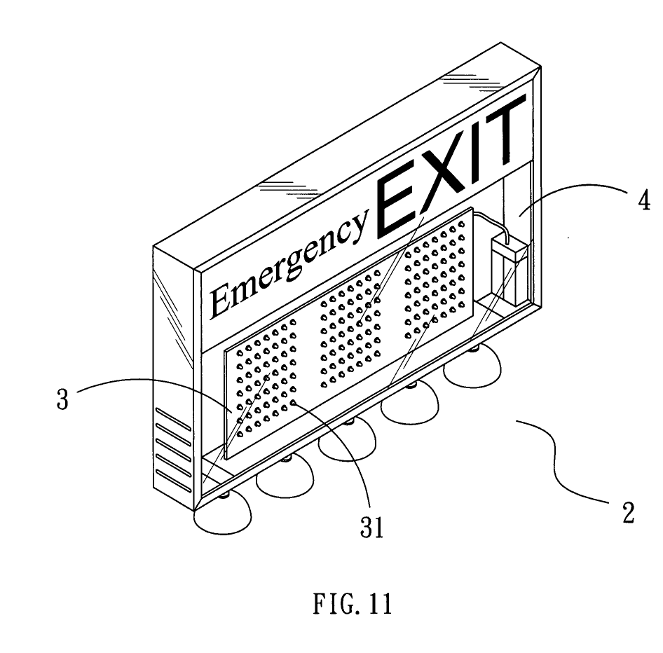

Referring to FIG. 11, a further embodiment of the present invention is shown therein. As can be clearly seen from this figure, the panel 4 of the dynamic emergency escape indicator 2 may be made of a transparent or a translucent material. In case of a fire, an emergency or a blackout, the light emitting device 3 controls the plurality of light emitting elements 31 thereof to be turned on and off to present the patterns or characters thereon in sequence so that, under the guide of the patterns or characters presented, the fleeing people can find the correct emergency exit or escape route to flee away from the scene of the emergency.

1. A dynamic emergency escape indicator, comprising:
a base;
a light emitting device, being disposed within the base and provided with a plurality of light emitting elements;
a panel, being disposed on a side of the base and corresponding to the light emitting device disposed within the base;
at least one lighting device, being disposed at an edge of the base, wherein a number of the lighting device can be increased or decreased depending on practical needs at a site where the indicator is installed; and
at least one power supply unit, being disposed within the base and configured to supply back-up power in case of emergency or fire;
wherein in case of emergency or fire, the light emitting device within the base turns the light emitting elements thereof on and off in sequence repeatedly to provide a dynamic indicating effect, and meanwhile, the at least one lighting device disposed at the edge of the base is turned on to provide lighting for illuminating a particular object.

2. The dynamic emergency escape indicator of claim 1, wherein the light emitting elements are light emitting diodes (LEDs), light bulbs, halogen lamps, fluorescent lamps or any other elements that emit light.

3. The dynamic emergency escape indicator of claim 1, wherein the panel is formed with a plurality of indicating patterns or characters.

4. The dynamic emergency escape indicator of claim 1, wherein the panel is made of a transparent material.

5. The dynamic emergency escape indicator of claim 1, wherein the lighting device is a light emitting diode (LED), a light bulb, a halogen lamp, a fluorescent lamp or any other element that provide lighting.

6. The dynamic emergency escape indicator of claim 1, wherein the lighting device is connected to the edge of the base via a universal coupling.

7. The dynamic emergency escape indicator of claim 1, wherein the power supply unit is a battery for storing electric power.

8. The dynamic emergency escape indicator of claim 1, further comprising a switch device which is configured to automatically switch to the power supply unit for continuous power supply in case of emergency or blackout.
